(19) United States
(12) Patent Application Publication
(10) Pub. No.: US 2024/0035846 A1
(43) Pub. Date: Feb. 1, 2024

(54) METHOD AND DEVICE FOR DETERMINING THE RELIABILITY OF A LOW-DEFINITION MAP

(71) Applicant: PSA AUTOMOBILES SA, Poissy (FR)

(72) Inventors: Olivier DESCHENES, MALAKOFF (FR); Alexis REY, ST. CLOUD (FR); Pierre Clement GAUTHIER, REIMS (FR); Luc VIVET, PARIS (FR); Soumia NID BOUHOU, CASABLANCA (MA)

(21) Appl. No.: 18/546,587

(22) PCT Filed: Feb. 4, 2022
(86) PCT No.: PCT/FR2022/050217

§ 371 Date: Aug. 15, 2023

(30) Foreign Application Priority Data
Mar. 15, 2021 (FR) FR2102516

(51) Int. Cl. G01C 21/00; B60W 60/00

(52) U.S. Cl. CPC G01C 21/3837; B60W 60/001; B60W 2552/15; B60W 2552/30

(57) ABSTRACT

The invention relates to a method and a device for determining the reliability of a low-definition map in order to improve the reliability of the activation of at least one driving-assistance system of an autonomous vehicle, said autonomous vehicle travelling on a road and comprising a navigation system and a perception system, the navigation system comprising said map and supplying at least one slope and at least one curvature of the road around said vehicle, referred to as a mapped slope and mapped curvature, the perception system supplying a slope and a trajectory of the road around said vehicle, referred to as a measured slope and measured trajectory, said method comprising the steps of:
Determining (201) a trajectory of the road;
Determining (202) a slope indicator;
Determining (203) a trajectory indicator;
Calculating (204) a correlation value;

Determining (205) a map reliability indicator.

### CROSS-REFERENCE TO RELATED APPLICATIONS

This application is the US National Stage under 35 USC § 371 of International Application No. PCT/FR2022/050217, filed Feb. 4, 2022, which claims the priority of French application 2102516 filed on Mar. 15, 2021, the content (text, drawings and claims) of both said applications being incorporated by reference herein.

### BACKGROUND

The methods and devices described herein belong to the field of autonomous vehicle driving-assistance systems. In particular, determination of the reliability of a low-definition map in order to improve the reliability of the activation of at least one driving-assistance system of an autonomous vehicle is described.

“Vehicle” is understood to mean any type of vehicle such as a motor vehicle, a moped, a motorcycle, a storage robot in a warehouse, etc. “Autonomous driving” of an “autonomous vehicle” is understood to mean any method capable of assisting with the driving of the vehicle. The method can thus consist of partially or totally directing the vehicle or of providing any type of assistance to a physical person driving the vehicle. The method thus covers all types of autonomous driving, from level 0 to level 5 in the scale of the International Organization of Motor Vehicle Manufacturers (OICA).

Among the known driving-assistance systems are, for example, lane-keeping devices, lane-changing devices, adaptive cruise control devices, etc.

A vehicle, comprising one of these devices, comprises numerous sensors such as a camera, a RADAR, a LIDAR, ultrasound, accelerometers, an inertial unit, position or location sensors, speed sensors, acceleration sensors, etc. It is known to process information by at least one computer on board the vehicle, which makes it able to perceive the environment. The term environment is understood to mean the exterior and interior of the vehicle. This perception of the environment makes it possible to measure a slope of a road on which the vehicle travels and to determine a trajectory of the road on which vehicle travels. Determining the trajectory of the road involves for example determining the coefficients of at least one polynomial that models the trajectory of the road. For example, the trajectory is divided into several segments or several portions. Each segment or portion is modeled by a polynomial.

Moreover, this vehicle also comprises a navigation system which comprises a means for locating itself and a map. There are different types of maps. A high-definition map, referred to as HD map, characterizes the lanes and attributes linked with the road such as a lane number, road curvatures, a slope of the road, road signs, etc. Moreover, with an HD map, the navigation system, which connects with servers outside the vehicle by telecommunication links, regularly updates the map. Thus, the attributes linked with the road are thus very up to date. In addition, in an HD map, the attributes are correctly positioned (1-meter resolution).

In a standard-definition map, SD map, the characterization of the lanes is less precise, and the attributes are not always correctly digitized (missing or inaccurate positioning to within several meters). The map is also updated less regularly. If this update is carried out manually and annually from a database of a map provider, the data are then 6 months old on average.

Document FR3090547 discloses a device for verifying a high-definition map of a motor vehicle. Document CN111767354 discloses a high-precision method for assessing cartographic precision. Document FR3082349 discloses a driving-assistance system, mounted on a vehicle. Document US2019/227545 discloses a device and method for driving assistance of a vehicle. Document US2007/299606 discloses a driving-assistance system. Document EP2282170 discloses a device for specifying the reliability of the information used for driving assistance.

Thanks to regular updates and accuracy of the attributes, HD maps are intrinsically reliable. Thus, it is known that ADAS systems of a vehicle comprising an HD map use information from the map to improve the functionalities of these ADAS systems. For example, these functionalities are capable of controlling the longitudinal and transverse dynamics of the vehicle by activating a driving-assistance system (for example modifying a setpoint speed, modifying a position of the vehicle in the lane, etc.).

Unfortunately, the cost to embed an HD map is very high with respect to the manufacturing cost of a vehicle. If the vehicle has an SD map embedded, it is dangerous to condition activations or modifications of setpoints of driving-assistance systems which directly control the steering and/or speed of the vehicle. An SD map is not reliable enough.

In order for a driving-assistance system to use information from the map, devices that calculate an instantaneous map reliability indicator are known. In particular, the positioning accuracy given by a GPS-type (Global Positioning System) device is used. However, these devices calculating an instantaneous map reliability indicator, on the one hand, assume that the information for calculating the indicator is continuously available and, on the other hand, are rather conceptual in the implementation.

Unfortunately, perception of the environment requires a large volume of information to be processed, and therefore a high computation load. Thus, in certain use cases (numerous vehicles around the autonomous vehicle, strong accelerations or decelerations, etc.) or weather conditions, certain perception information is regularly missing or arrives late. Moreover, perception information originating from image processing is also regularly missing due to the available visibility (for example, a truck might conceal a road sign at the edge of the lane). Thus, the periodic calculations of an instantaneous map reliability indicator as the vehicle is travelling on a road vary abruptly and randomly. The indicator is thus unstable, unreliable and unusable, for safety reasons, in driving-assistance systems.

### SUMMARY

One object is to remedy the aforementioned problem, in particular to improve the reliability of the information, lane characteristics and attributes, originating from an SD map.

To this end, a first aspect relates to a method for determining the reliability of a low-definition map in order to improve the reliability of the activation of at least one driving-assistance system of an autonomous vehicle, said autonomous vehicle travelling on a road and comprising a navigation system and a perception system, the navigation system comprising said map and supplying at least one slope and at least one curvature of the road around said vehicle, referred to as mapped slope and mapped curvature, the perception system supplying a slope and a trajectory of the road around said vehicle, referred to as measured slope and measured trajectory, said method being updated periodically when said vehicle is travelling on the road and including the steps of:
Determining a trajectory of the road, referred to as mapped trajectory, from at least the mapped curvature;
Determining a slope indicator indicating a match between the mapped slope and the measured slope, the slope indicator being a number comprised between 0 and 1, the value 1 indicating a strong match and the value 0 indicating no match;
Determining a trajectory indicator indicating a match between the mapped trajectory and the measured trajectory, the trajectory indicator being a number comprised between 0 and 1, the value 1 indicating a strong match and the value 0 indicating no match;
Calculating a correlation value from the slope indicator and the trajectory indicator;
Determining a map reliability indicator—reliable or unreliable—the indicator being reliable if the correlation value is greater than a predetermined threshold.

Thus, if the reliability is good, this means that the mapped data are substantially equal to the measured data. The navigation system then correctly positions the vehicle on the map, and, also, the map is locally reliable (from the perception distance). A driving-assistance system that controls the longitudinal and/or lateral dynamics of the vehicle can rely on the data originating from the map.

The use of the two indicators makes updating the correlation value predictive and responsive. It is predictive by virtue of the trajectory indicator which is based on a distant vision of the perception system (between 30 and 300 meters for example). It is responsive by virtue of the slope indicator which is based on a very close vision of the vehicle, the measurement of the slope is only known where the vehicle is travelling or has already travelled.

Furthermore, the reliability is also robust against the short random detection and location errors due to a computation overload. This robustness is due to the calculation of the correlation value and to a determination by level.

Advantageously, the map reliability indicator is determined on four levels—strong, medium, insufficient or indefinite—the levels being defined depending on the correlation value.

Thus, if good reliability has been previously determined, then if the correlation value decreases in the absence of a mapped and/or measured trajectory or slope, the reliability does not directly become insufficient or indefinite, which would risk suddenly stopping a driving assistance.

Advantageously, the slope indicator increases or decreases according to a calculated gradient, the gradient depending on the deviation between the mapped slope and the measured slope.

Thus, the history is taken into account if good reliability was previously determined, then if the slope indicator decreases, the reliability does not directly become low reliability or indeterminate incoherence, which would risk suddenly stopping a driving assistance.

Advantageously, the trajectory indicator increases or decreases according to a calculated gradient, the gradient depending on the lateral deviation between the mapped trajectory and the measured trajectory.

Thus, the history is taken into account if good reliability was previously determined, then if the trajectory indicator decreases, the reliability does not directly become low reliability or indeterminate incoherence, which would risk suddenly stopping a driving assistance.

Advantageously, the correlation value is a weighting between the slope indicator and the trajectory indicator.

Advantageously, the determination of the mapped trajectory is obtained from interpolation of the at least one mapped curvature.

A second aspect relates to a device comprising a memory unit associated with at least one processor configured to implement the method according to the first aspect.

Also related is a vehicle including the device.

Also related is a computer program comprising instructions suitable for executing the steps of the method, according to the first aspect, when said program is executed by at least one processor.

### BRIEF DESCRIPTION OF THE FIGURES

Other features and advantages will become apparent from the description of the non-limiting embodiments below, with reference to the appended figures, in which:

FIG. 1 schematically shows a device, according to a particular embodiment.

FIG. 2 schematically shows a method for determining a reliability of a low-definition map, according to a particular embodiment.

### DETAILED DESCRIPTION

The methods and devices are described below in their non-limiting application to the case of an autonomous motor vehicle circulating on a road or on a traffic lane. Other applications such as a robot in a storage warehouse or else a motorcycle on a country road are also conceivable.

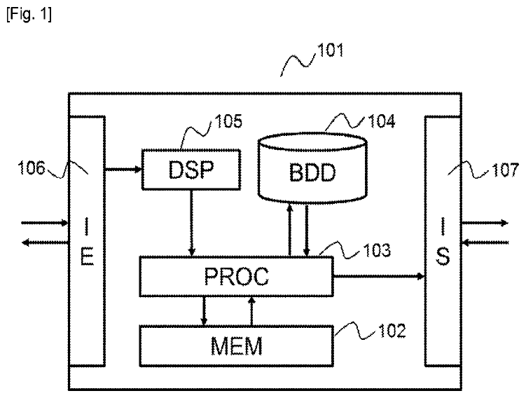

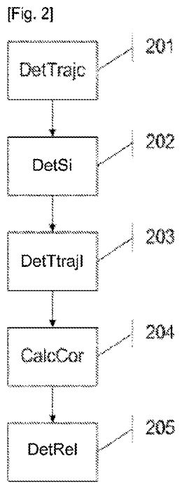

FIG. 1 depicts an example of a device 101 comprised in the vehicle, in a network (“cloud”) or in a server. This device 101 can be used as a centralized device in charge of at least some steps of the method described below with reference to FIG. 2. In one embodiment, it corresponds to an autonomous driving computer.

The device 101 is comprised in the vehicle.

This device 101 may take the form of a housing comprising printed circuit boards, any type of computer or else a mobile telephone (smartphone).

The device 101 comprises a random-access memory 102 for storing instructions for the implementation by a processor 103 of at least one step of the method as described hereinbefore. The device also comprises mass storage 104 for storing data that are intended to be kept after the implementation of the method.

The device 101 may further comprise a digital signal processor (DSP) 105. This DSP 105 receives data for shaping, demodulating and amplifying these data in a manner known per se.

The device 101 also comprises an input interface 106 for receiving the data implemented by the method and an output interface 107 for transmitting the data implemented by the method.

FIG. 2 schematically shows a method for determining a reliability of a low-definition map, according to a particular embodiment.

The method is implemented by a device 101 in an autonomous vehicle that comprises at least one driving-assistance system. Said autonomous vehicle travels on a road and comprises a navigation system and a perception system.

Said navigation system comprises said map and provides at least one slope and at least one curvature of the road around said vehicle, referred to as mapped slope and mapped curvature. Said perception system provides a slope and a trajectory of the road around said vehicle, referred to as measured slope and measured trajectory.

When the vehicle is travelling, said method is updated periodically, for example every 100 ms, but another value is possible. In one embodiment, the update is also carried out upon detecting an event or upon a request from one of the driving-assistance systems.

Step 201, DetTrajc, is a step of determining a trajectory of the road, referred to as mapped trajectory, from the at least the mapped curvature.

In a preferred mode of operation, the navigation system provides information around the vehicle in a horizon covering, for example, from 3000 meters in front of the vehicle to −500 meters (thus behind the vehicle). Within this horizon, the map is divided into segments. Each segment represents a portion of the road on which the vehicle is travelling. A portion therefore comprises a distance. The at least one mapped curvature corresponds to one curvature per segment as well as to the length of the segment. Placed end-to-end, the set of segments represents the road on which vehicle is travelling on the given horizon.

Thus, from the curvatures of each segment, a trajectory of the road, referred to as mapped trajectory, is determined. This determination is carried out, for example, by determining a polynomial calculated from the data of the at least mapped curvature. In another example, this determination is obtained from interpolating the at least one mapped curvature.

Step 202, Detlp, is a step of determining a slope indicator indicating a match between the mapped slope and the measured slope, the slope indicator being a number comprised between 0 and 1, the value 1 indicating a strong match and the value 0 indicating no match.

In one operating mode, if the absolute and/or relative deviation between the mapped slope, slope provided by the navigation system at the location where the vehicle is travelling, and the measured slope is less than a predetermined threshold, then the slope indicator is 1, otherwise the slope indicator is 0.

In a preferred operating mode, the slope indicator increases or decreases according to a calculated gradient, the gradient depending on the deviation between the mapped slope and the measured slope. The gradient is a number comprised between −1 and 1. Depending on the deviation, a gradient value is selected. For example, if the deviation is less than a threshold, the gradient is equal to 0.002, otherwise, the gradient is equal to −0.002. Thus, in each period, the slope indicator is updated by taking into account the history, which ensures robustness against random measurement errors and/or errors and/or inaccuracies of the map.

In another operating mode, the gradient also depends on the variation of the measured slope. In the event of strong acceleration or deceleration, the measured slope is temporarily more strongly affected by errors. For example, the gradient is equal to 0.004 if the variation of the slope is less than another predetermined threshold and if the deviation between the mapped slope and the measured slope is less than a predetermined threshold.

Step 203, DetTrajl, is a step of determining a trajectory indicator indicating a match between the mapped trajectory and the measured trajectory, the trajectory indicator being a number comprised between 0 and 1, the value 1 indicating a strong match and the value 0 indicating no match.

In one operating mode, if the absolute and/or relative lateral deviation between the mapped trajectory and the measured trajectory is less than a predetermined threshold, then the slope indicator is 1, otherwise the slope indicator is 0.

In one preferred operating mode, the trajectory indicator increases or decreases according to a calculated gradient, the gradient depending on the lateral deviation between the mapped trajectory and the measured trajectory. The gradient is a number comprised between −1 and 1. Depending on the deviation, a gradient value is selected. For example, if the deviation is less than a threshold, the gradient is equal to 0.002, otherwise, the gradient is equal to −0.002. Thus, in each period, the trajectory indicator is updated by taking into account the history, which ensures robustness against random measurement errors and/or errors and/or inaccuracies of the map.

In another operating mode, the gradient depends on a combination of the difference between the mapped trajectory and the measured trajectory for each segment. The greater the number of differences below a threshold, the higher the gradient.

Step 204, CalcCor, is a step of calculating a correlation value from the slope indicator and the trajectory indicator. Advantageously, the correlation value is a weighting between the slope indicator and the trajectory indicator. The correlation value is a number comprised between 0 and 1. For example, the correlation value is equal to 40% of the slope indicator plus 60% of the trajectory indicator. The percentages given are by way of example, other values are possible. Ideally, the percentage of the slope indicator is less than the trajectory indicator, the trajectory indicator being more robust. The percentage may also depend on other parameters, such as on at least one threshold of the variation in the measured slope.

Step 205, DetRel, is a step of determining a map reliability indicator—reliable or unreliable—the indicator being reliable if the correlation value is greater than a predetermined threshold. Advantageously, the map reliability indicator is determined on four levels—strong, medium, insufficient or indefinite—the levels being defined depending on the correlation value. If the trajectory indicator and the slope indicator vary according to a gradient, the history is taken into account. Thus, if the correlation value is close to 1, this means that for a period of several tens of seconds the slope and trajectory indicators are close to 1 and thus there is a very good match between the map and the environment. The map is therefore reliable and it will certainly be reliable for the next tens of seconds, even if there are strong accelerations/decelerations of the vehicle, which degrades the measurements of the slope, and if there are steering wheel movements to perform an avoidance maneuver that disrupt the determination of the trajectory measured by the perception device.

The described methods and devices are not limited to the embodiments described above by way of example; it extends to other variants. For example, numerical values were given in particular for the gradients. Other values are possible and depend, for example on the refresh period of the procedure.

1. A method for determining the reliability of a low-definition map in order to improve the reliability of the activation of at least one driving-assistance system of an autonomous vehicle, said autonomous vehicle travelling on a road and comprising a navigation system and a perception system, the navigation system comprising said map and supplying at least one slope and at least one curvature of the road around said vehicle, referred to as mapped slope and mapped curvature, the perception system supplying a slope and a trajectory of the road around said vehicle, referred to as measured slope and measured trajectory, said method being updated periodically when said vehicle is travelling on the road and including the steps of:
Determining a trajectory of the road, referred to as mapped trajectory, from at least the mapped curvature;
Determining a slope indicator indicating a match between the mapped slope and the measured slope, the slope indicator being a number comprised between 0 and 1, the value 1 indicating a strong match and the value 0 indicating no match;
Determining a trajectory indicator indicating a match between the mapped trajectory and the measured trajectory, the trajectory indicator being a number comprised between 0 and 1, the value 1 indicating a strong match and the value 0 indicating no match;
Calculating a correlation value from the slope indicator and the trajectory indicator;
Determining a map reliability indicator—reliable or unreliable—the indicator being reliable if the correlation value is greater than a predetermined threshold.

2. The method according to claim 1, wherein the map reliability indicator is determined on four levels—strong, medium, insufficient or indefinite—the levels being defined depending on the correlation value.

3. The method according to claim 1, wherein the slope indicator increases or decreases according to a calculated gradient, the gradient depending on the deviation between the mapped slope and the measured slope.

4. The method according to claim 1, wherein the trajectory indicator increases or decreases according to a calculated gradient, the gradient depending on the lateral deviation between the mapped trajectory and the measured trajectory.

5. The method according to claim 1, wherein the correlation value is a weighting between the slope indicator and the trajectory indicator.

6. The method according to claim 1, wherein the determination of the mapped trajectory is obtained from interpolation of the at least one mapped curvature.

7. A device comprising a memory associated with at least one processor configured to perform the method according to claim 1.

8. A vehicle comprising the device according to claim 7.

9. A computer program comprising instructions suitable for executing the steps of the method according to claim 1 when said program is executed by at least one processor.
